(19) United States
(12) Patent Application Publication
(10) Pub. No.: US 2025/0335997 A1
(43) Pub. Date: Oct. 30, 2025

(54) METHOD AND SYSTEM FOR PREFERENCE-AWARE FINANCIAL PLANNING

(71) Applicant: JPMorgan Chase Bank, N.A., New York, NY (US)

(72) Inventors: Kassiani PAPASOTIRIOU, New York, NY (US); Alberto POZANCO, Madrid (ES); Nicolas MARCHESOTTI, London (GB); Daniel BORRAJO, Pozuelo de Alarcon (ES); Ibrahim ELGAZAERY, Brooklyn, NY (US); Jennifer M. NUGENT, New York, NY (US); Mitesh KAPADIA, Colonia, NJ (US); Nicole NIMETH, Hoboken, NJ (US); Caitlin DOVER, Bronx, NY (US); Eli COLLINSON, New York, NY (US); Winston Nesh NESAYYAN, Avenel, NJ (US); Oleksandr BOGUN, New York, NY (US); Craig ALTERMAN, New York, NY (US); Prashant SHAH, Iselin, NJ (US); Hemathri BALAKRISHNAN, Frisco, TX (US); Manuela VELOSO, New York, NY (US)

(73) Assignee: JPMorgan Chase Bank, N.A., New York, NY (US)

(21) Appl. No.: 18/656,199

(22) Filed: May 6, 2024

(30) Foreign Application Priority Data
Apr. 29, 2024 (GR) 20240100307

(51) Int. Cl. G06Q 40/06

(52) U.S. Cl. CPC G06Q 40/06

(57) ABSTRACT

A method for providing a tool for individualized financial planning and navigation that is tailored to user preferences and offers flexibility with respect to modifications in financial goals is provided. The method includes: receiving information that includes a financial goal of a user; applying an optimization algorithm that is designed to analyze the information with respect to the financial goal; and using a result thereof to determine an achievable percentage of the financial goal of the user and recommendation(s) for modifying the information in order to increase the achievable percentage of the financial goal. The information further includes a number of time steps for achieving the goal, a first amount of money that the user contributes per time step towards the goal, and a second amount of money that the user expects to save by the end of the time steps.

### CROSS-REFERENCE TO RELATED APPLICATIONS

This application claims priority benefit from Greek Application No. 20240100307, filed on Apr. 29, 2024 in the Greek Patent Office, which is hereby incorporated by reference in its entirety.

### BACKGROUND

### 1. Field of the Disclosure

This technology generally relates to methods and systems for financial planning, and more particularly to methods and systems for providing a tool for individualized financial planning and navigation that is tailored to user preferences and offers flexibility with respect to modifications in financial goals.

### 2. Background Information

One service that is generally provided by large financial institutions, such as banks, is financial planning advice. In many situations, such advice is typically based on conventional textbook-style philosophies that are broadly applicable to large classes of customers, while also taking into account risk factors that each particular customer may weigh.

A user can set up a financial goal by defining a goal timeline, specifying when they intend to achieve it, a target savings amount to accumulate by that point, and the amount they plan to contribute towards the goal from the current time until the specified timeline. However, the user may not be able to reach the entire savings amount based on their preferred contributions, the due date of the goal, and other factors, such as existing savings. Consequently, the user can only achieve a certain percentage of their savings goal.

To increase the funding percentage, users can modify their goal, considering options such as extending the timeline, contributing more, or adjusting the desired savings amount. At the same time, depending on user preferences and financial backgrounds, different components of the goal might be easier for one to modify than others. For example, one user who does not have overflow money at the end of the month might find it difficult to increase their contributions towards their goal, and they would rather extend the timeline of the goal by a few years.

Recently, as a result of increases in computer processing power and speed, it has become more feasible to use large volumes of data to provide fact-based analysis of a variety of situations. Such a use of historical data has not been applied in conventional financial planning scenarios.

Accordingly, there is a need for a mechanism for providing a tool for individualized financial planning and navigation that is tailored to user preferences and offers flexibility with respect to modifications in financial goals.

### SUMMARY

The present disclosure, through one or more of its various aspects, embodiments, and/or specific features or sub-components, provides, inter alia, various systems, servers, devices, methods, media, programs, and platforms for providing a tool for individualized financial planning and navigation that is tailored to user preferences and offers flexibility with respect to modifications in financial goals.

According to an aspect of the present disclosure, a method for providing a tool for individualized financial planning is provided. The method is implemented by at least one processor. The method includes: receiving, by the at least one processor from a user, first information that relates to the user, the first information including at least one financial goal of the user; applying, to the first information by the at least one processor, an optimization algorithm that is designed to analyze the first information with respect to the at least one financial goal; and determining, by the at least one processor based on a result of the applying of the optimization algorithm to the first information, an achievable percentage of the at least one financial goal of the user and at least one recommendation for modifying the first information in order to increase the achievable percentage of the at least one financial goal of the user.

The first information may further include a first predetermined number of time steps for achieving the at least one financial goal, a first amount of money that the user contributes per time step towards the at least one financial goal, and a second amount of money that the user expects to save after the first predetermined number of time steps.

The applying of the optimization algorithm may include: assigning a first user preference that corresponds to a willingness of the user to commit to the first predetermined number of time steps; assigning a second user preference that corresponds to a willingness of the user to commit to the first amount of money; and assigning a third user preference that corresponds to a willingness of the user to commit to the second amount of money. Each of the first user preference, the second user preference, and the third user preference may be a real number within a range of between zero (0) and one (1).

The applying of the optimization algorithm may further include: assigning a first weight that corresponds to the first user preference; assigning a second weight that corresponds to the second user preference; assigning a third weight that corresponds to the third user preference; assigning a fourth weight that corresponds to an importance of a predetermined percentage of the second amount of money; assigning a fifth weight that corresponds to a deviation from user input for the first predetermined number of time steps; assigning a sixth weight that corresponds to a deviation from user input for the first amount of money; and assigning a seventh weight that corresponds to a deviation from user input for the second amount of money. The determining of the achievable percentage of the at least one financial goal of the user and the determining of the at least one recommendation for modifying the first information may be based on the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

The method may further include generating a plurality of candidate recommendations for modifying the first information, each respective candidate recommendation including a respective tuple goal suggestion; and determining a respective quality of the respective tuple goal suggestion by using each of the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

The applying of the optimization algorithm may further include selecting a predetermined number of tuple goal suggestions for which the respective quality exceeds a predetermined threshold and corresponding values of each selected tuple goal suggestion are mutually diverse.

The predetermined number of tuple goal suggestions may include at least three mutually diverse tuple goal suggestions, including: a first tuple goal suggestion having a second predetermined number of time steps that is greater than the first predetermined number of time steps for achieving the at least one financial goal, a third amount of money that is less than the first amount of money to be contributed by the user per time step towards the at least one financial goal, and a fourth amount of money that is different from the second amount of money to be saved by the user; a second tuple goal suggestion having a third predetermined number of time steps that is less than the first predetermined number of time steps for achieving the at least one financial goal, a fifth amount of money that is greater than the first amount of money to be contributed by the user per time step towards the at least one financial goal, and a sixth amount of money that is different from each of the second amount of money and the fourth amount of money to be saved by the user; and at least a third tuple goal suggestion having a fourth predetermined number of time steps that is different from each of the first predetermined number of time steps, the second predetermined number of time steps, and the third predetermined number of time steps for achieving the at least one financial goal, a seventh amount of money that is different from each of the first amount of money, the third amount of money, and the fifth amount of money to be contributed by the user per time step towards the at least one financial goal, and an eighth amount of money that is different from each of the second amount of money, the fourth amount of money, and the sixth amount of money to be saved by the user.

The method may further include displaying, by the at least one processor on a user interface, a result of the determining of the achievable percentage of the at least one financial goal of the user and the at least one recommendation for modifying the first information.

According to another aspect of the present disclosure, a computing apparatus for providing a tool for individualized financial planning is provided. The computing apparatus includes a processor; a memory; a display; and a communication interface coupled to each of the processor, the memory, and the display. The processor is configured to: receive, from a user via the communication interface, first information that relates to the user, the first information including at least one financial goal of the user; apply, to the first information, an optimization algorithm that is designed to analyze the first information with respect to the at least one financial goal; and determine, based on a result of the application of the optimization algorithm to the first information, an achievable percentage of the at least one financial goal of the user and at least one recommendation for modifying the first information in order to increase the achievable percentage of the at least one financial goal of the user.

The first information may further include a first predetermined number of time steps for achieving the at least one financial goal, a first amount of money that the user contributes per time step towards the at least one financial goal, and a second amount of money that the user expects to save after the first predetermined number of time steps.

The processor may be further configured to perform the applying of the optimization algorithm by: assigning a first user preference that corresponds to a willingness of the user to commit to the first predetermined number of time steps; assigning a second user preference that corresponds to a willingness of the user to commit to the first amount of money; and assigning a third user preference that corresponds to a willingness of the user to commit to the second amount of money. Each of the first user preference, the second user preference, and the third user preference may be a real number within a range of between zero (0) and one (1).

The processor may be further configured to perform the applying of the optimization algorithm by: assigning a first weight that corresponds to the first user preference; assigning a second weight that corresponds to the second user preference; assigning a third weight that corresponds to the third user preference; assigning a fourth weight that corresponds to an importance of a predetermined percentage of the second amount of money; assigning a fifth weight that corresponds to a deviation from user input for the first predetermined number of time steps; assigning a sixth weight that corresponds to a deviation from user input for the first amount of money; and assigning a seventh weight that corresponds to a deviation from user input for the second amount of money. The determination of the achievable percentage of the at least one financial goal of the user and the determination of the at least one recommendation for modifying the first information may be based on the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

The processor may be further configured to: generate a plurality of candidate recommendations for modifying the first information, each respective candidate recommendation including a respective tuple goal suggestion; and determine a respective quality of the respective tuple goal suggestion by using each of the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

The processor may be further configured to perform the applying of the optimization algorithm by selecting a predetermined number of tuple goal suggestions for which the respective quality exceeds a predetermined threshold and corresponding values of each selected tuple goal suggestion are mutually diverse.

The predetermined number of tuple goal suggestions may include at least three mutually diverse tuple goal suggestions, including: a first tuple goal suggestion having a second predetermined number of time steps that is greater than the first predetermined number of time steps for achieving the at least one financial goal, a third amount of money that is less than the first amount of money to be contributed by the user per time step towards the at least one financial goal, and a fourth amount of money that is different from the second amount of money to be saved by the user; a second tuple goal suggestion having a third predetermined number of time steps that is less than the first predetermined number of time steps for achieving the at least one financial goal, a fifth amount of money that is greater than the first amount of money to be contributed by the user per time step towards the at least one financial goal, and a sixth amount of money that is different from each of the second amount of money and the fourth amount of money to be saved by the user; and at least a third tuple goal suggestion having a fourth predetermined number of time steps that is different from each of the first predetermined number of time steps, the second predetermined number of time steps, and the third predetermined number of time steps for achieving the at least one financial goal, a seventh amount of money that is different from each of the first amount of money, the third amount of money, and the fifth amount of money to be contributed by the user per time step towards the at least one financial goal, and an eighth amount of money that is different from each of the second amount of money, the fourth amount of money, and the sixth amount of money to be saved by the user.

The processor may be further configured to cause the display to display, on a user interface, a result of the determination of the achievable percentage of the at least one financial goal of the user and the at least one recommendation for modifying the first information.

According to yet another exemplary embodiment, a non-transitory computer readable storage medium storing instructions for providing a tool for individualized financial planning is provided. The storage medium includes a set of executable code which, when executed by a processor, causes the processor to: receive, from a user, first information that relates to the user, the first information including at least one financial goal of the user; apply, to the first information, an optimization algorithm that is designed to analyze the first information with respect to the at least one financial goal; and determine, based on a result of the application of the optimization algorithm to the first information, an achievable percentage of the at least one financial goal of the user and at least one recommendation for modifying the first information in order to increase the achievable percentage of the at least one financial goal of the user.

The first information may further include a first predetermined number of time steps for achieving the at least one financial goal, a first amount of money that the user contributes per time step towards the at least one financial goal, and a second amount of money that the user expects to save after the first predetermined number of time steps.

When executed by the processor, the executable code may further cause the processor to apply the optimization algorithm by: assigning a first user preference that corresponds to a willingness of the user to commit to the first predetermined number of time steps; assigning a second user preference that corresponds to a willingness of the user to commit to the first amount of money; and assigning a third user preference that corresponds to a willingness of the user to commit to the second amount of money. Each of the first user preference, the second user preference, and the third user preference may be a real number within a range of between zero (0) and one (1).

When executed by the processor, the executable code may further cause the processor to apply the optimization algorithm by: assigning a first weight that corresponds to the first user preference; assigning a second weight that corresponds to the second user preference; assigning a third weight that corresponds to the third user preference; assigning a fourth weight that corresponds to an importance of a predetermined percentage of the second amount of money; assigning a fifth weight that corresponds to a deviation from user input for the first predetermined number of time steps; assigning a sixth weight that corresponds to a deviation from user input for the first amount of money; and assigning a seventh weight that corresponds to a deviation from user input for the second amount of money. The determination of the achievable percentage of the at least one financial goal of the user and the determination of the at least one recommendation for modifying the first information may be based on the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a tool for individualized financial planning and navigation that is tailored to user preferences and offers flexibility with respect to modifications in financial goals.

FIG. 4 is a flowchart of an exemplary process for implementing a method for providing a tool for individualized financial planning and navigation that is tailored to user preferences and offers flexibility with respect to modifications in financial goals.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

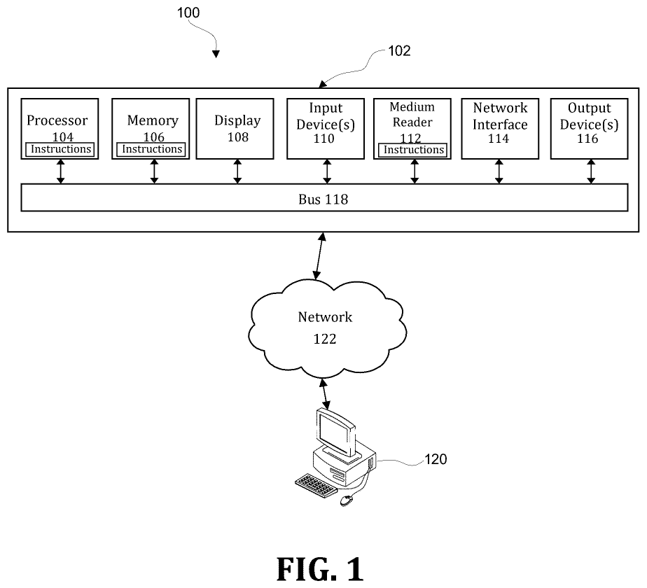

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a tool for individualized financial planning and navigation that is tailored to user preferences and offers flexibility with respect to modifications in financial goals.

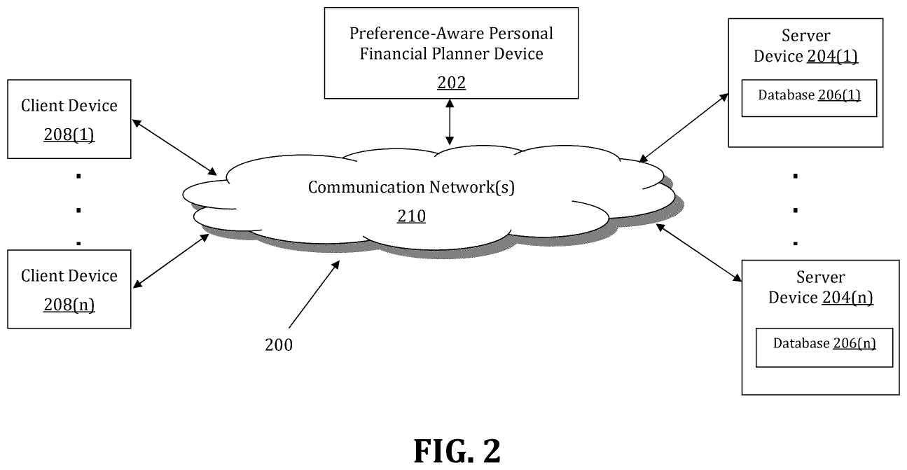

Referring to FIG. 2, a schematic of an exemplary network environment 200 for implementing a method for providing a tool for individualized financial planning and navigation that is tailored to user preferences and offers flexibility with respect to modifications in financial goals is illustrated. In an exemplary embodiment, the method is executable on any networked computer platform, such as, for example, a personal computer (PC).

The method for providing a tool for individualized financial planning and navigation that is tailored to user preferences and offers flexibility with respect to modifications in financial goals may be implemented by a Preference-Aware Personal Financial Planner (PAPFP) device 202. The PAPFP device 202 may be the same or similar to the computer system 102 as described with respect to FIG. 1. The PAPFP device 202 may store one or more applications that can include executable instructions that, when executed by the PAPFP device 202, cause the PAPFP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PAPFP device 202 itself, may be located in virtual server(s) running in a cloud-based computing environment rather than being tied to one or more specific physical network computing devices. Also, the application(s) may be running in one or more virtual machines (VMs) executing on the PAPFP device 202. Additionally, in one or more embodiments of this technology, virtual machine(s) running on the PAPFP device 202 may be managed or supervised by a hypervisor.

In the network environment 200 of FIG. 2, the PAPFP device 202 is coupled to a plurality of server devices 204(1)-204(n) that hosts a plurality of databases 206(1)-206(n), and also to a plurality of client devices 208(1)-208(n) via communication network(s) 210. A communication interface of the PAPFP device 202, such as the network interface 114 of the computer system 102 of FIG. 1, operatively couples and communicates between the PAPFP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PAPFP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PAPFP devices that efficiently implement a method for providing a tool for individualized financial planning and navigation that is tailored to user preferences and offers flexibility with respect to modifications in financial goals.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PAPFP device 202 may be a standalone device or integrated with one or more other devices or apparatuses, such as one or more of the server devices 204(1)-204(n), for example. In one particular example, the PAPFP device 202 may include or be hosted by one of the server devices 204(1)-204(n), and other arrangements are also possible. Moreover, one or more of the devices of the PAPFP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PAPFP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical data that relates to outcomes of financial actions for a large group of customers and data that relates to customer-specific financial planning information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PAPFP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PAPFP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PAPFP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PAPFP device 202, the server devices 204(1)-204(n), or the client devices 208(1)-208(n), for example, may be configured to operate as virtual instances on the same physical machine. In other words, one or more of the PAPFP device 202, the server devices 204(1)-204(n), or the client devices 208(1)-208(n) may operate on the same physical device rather than as separate devices communicating through communication network(s) 210. Additionally, there may be more or fewer PAPFP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

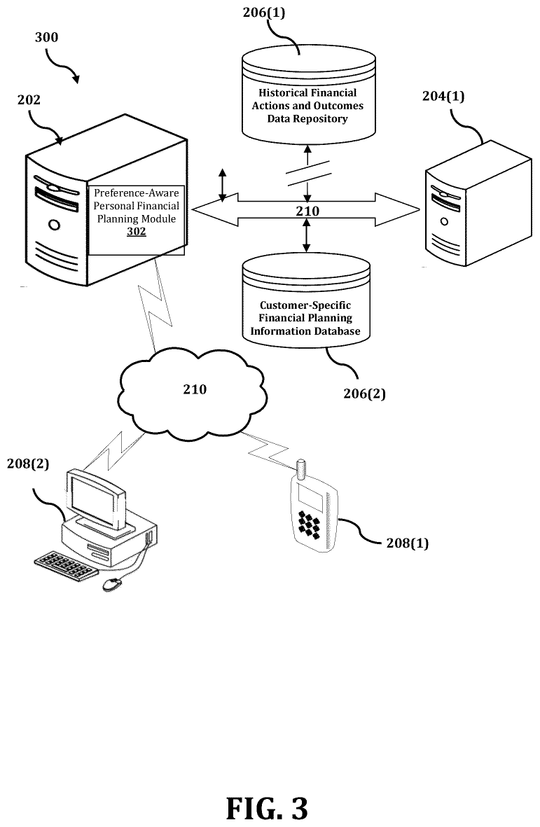

The PAPFP device 202 is described and illustrated in FIG. 3 as including a preference-aware personal financial planning module 302, although it may include other rules, policies, modules, databases, or applications, for example. As will be described below, the preference-aware personal financial planning module 302 is configured to implement a method for providing a tool for individualized financial planning and navigation that is tailored to user preferences and offers flexibility with respect to modifications in financial goals.

An exemplary process 300 for implementing a mechanism for providing a tool for individualized financial planning and navigation that is tailored to user preferences and offers flexibility with respect to modifications in financial goals by utilizing the network environment of FIG. 2 is illustrated as being executed in FIG. 3. Specifically, a first client device 208(1) and a second client device 208(2) are illustrated as being in communication with PAPFP device 202. In this regard, the first client device 208(1) and the second client device 208(2) may be “clients” of the PAPFP device 202 and are described herein as such. Nevertheless, it is to be known and understood that the first client device 208(1) and/or the second client device 208(2) need not necessarily be “clients” of the PAPFP device 202, or any entity described in association therewith herein. Any additional or alternative relationship may exist between either or both of the first client device 208(1) and the second client device 208(2) and the PAPFP device 202, or no relationship may exist.

Further, PAPFP device 202 is illustrated as being able to access a historical financial actions and outcomes data repository 206(1) and a customer-specific financial planning information database 206(2). The preference-aware personal financial planning module 302 may be configured to access these databases for implementing a method for providing a tool for individualized financial planning and navigation that is tailored to user preferences and offers flexibility with respect to modifications in financial goals.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PAPFP device 202 via broadband or cellular communication. Of course, these embodiments are merely exemplary and are not limiting or exhaustive.

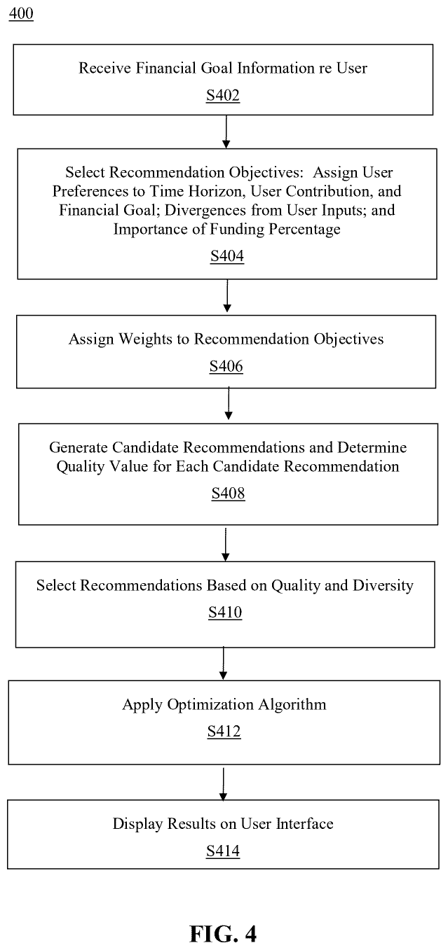

Upon being started, the preference-aware personal financial planning module 302 executes a process for providing a tool for individualized financial planning and navigation that is tailored to user preferences and offers flexibility with respect to modifications in financial goals. An exemplary process for providing a tool for individualized financial planning and navigation that is tailored to user preferences and offers flexibility with respect to modifications in financial goals is generally indicated at flowchart 400 in FIG. 4.

In process 400 of FIG. 4, at step S402, the preference-aware personal financial planning module 302 receives personal and financial information that pertains to a user. The personal and financial information includes at least one financial goal of the user, such as, for example, any one or more of an amount of increase or decrease in savings or income or discretionary spending or non-discretionary spending by a projected date; a proposed purchase by a projected date; and a retirement as of a projected date. For example, a financial goal may be to increase a savings amount by a particular amount or a particular percentage within a specified number of years. As another example, a financial goal may be to purchase a house or some other relatively expensive item within a particular amount of time, or to fund a college education that is expected to commence at a particular time. As yet another example, a person may have a goal of being able to retire with a specific minimum amount of savings by a certain date.

In an exemplary embodiment, the personal and financial information includes at least three items: 1) a number of time intervals, such as months or years, that are planned for achieving the financial goal; 2) a first amount of money that the user plans to contribute in each time interval toward achieving the financial goal; and 3) a second amount of money that the user expects to have saved at the end of the planned number of time intervals.

At step S404, the preference-aware personal financial planning module 302 selects recommendation objectives that relate to user preferences, divergences from user inputs, and an importance of a funding percentage. Regarding user preferences, the preference-aware personal financial planning module 302 assigns a user preference to each of the three information items described above, i.e., 1) a first user preference that corresponds to the number of time intervals that are planned for achieving the financial goal; 2) a second user preference that corresponds to the first amount of money that the user plans to contribute in each time interval toward achieving the financial goal; and 3) a third user preference that corresponds to the second amount of money that the user expects to have saved at the end of the planned number of time intervals. In an exemplary embodiment, each of these user preferences is a real number within a range of between zero (0) and one (1).

At step S406, the preference-aware personal financial planning module 302 assigns a set of weights to the user preferences and also to various factors to be considered in generating potential recommendations for increasing the achievable percentage of the financial goal. In an exemplary embodiment, the set of weights to be assigned includes any one or more of the following: a first weight that corresponds to the first user preference; a second weight that corresponds to the second user preference; a third weight that corresponds to the third user preference; a fourth weight that corresponds to an importance of a predetermined percentage of the second amount of money, i.e., the expected total savings amount; a fifth weight that corresponds to a deviation from user input for the number of time intervals that are planned for achieving the financial goal; assigning a sixth weight that corresponds to a deviation from user input for the first amount of money; and assigning a seventh weight that corresponds to a deviation from user input for the second amount of money.

At step S408, the preference-aware personal financial planning module 302 generates a set of candidate recommendations for increasing the achievable percentage of the financial goal, and then uses the user preferences assigned in step S404 and the weights assigned in step S406 to determine a respective quality value for each candidate recommendation. In an exemplary embodiment, each candidate recommendation includes a tuple goal suggestion that includes adjustments to each of the three values that correspond to the three information items described above, i.e., 1) the number of time intervals that are planned for achieving the financial goal; 2) the first amount of money that the user plans to contribute in each time interval toward achieving the financial goal; and 3) the second amount of money that the user expects to have saved at the end of the planned number of time intervals. In an exemplary embodiment, the quality values are determined by using a predetermined formula that is described in further detail below.

At step S410, the preference-aware personal financial planning module 302 selects a predetermined number of recommendations from among the candidate recommendations generated in step S408. In an exemplary embodiment, the selection of recommendations is based on the quality values and is also based on diversity, i.e., the inclusion of recommendations for which each of the three adjusted values in each respective tuple goal suggestion is different from each of the three adjusted values in the other tuple goal suggestions included in the other selected recommendations. For example, the number of time intervals for achieving the financial goal may be increased or decreased in each respective tuple goal suggestion; the amount of money that the user plans to contribute may also be increased or decreased in each respective tuple goal suggestion; and the amount of money expected to have been saved may also vary in each respective tuple goal suggestion.

At step S412, the preference-aware personal financial planning module 302 applies an optimization algorithm to the personal and financial data received in step S402, based on the recommendation objectives selected in step S404 and the weights assigned in step S406, and further based on the recommendations selected in step S410. In an exemplary embodiment, the optimization algorithm is designed to analyze the three items of information with respect to the financial goal.

At step S414, the preference-aware personal financial planning module 302 displays results of the process 400 on a user interface. The results may include the determined achievable percentage of the financial goal and each selected recommendation for modifying the information items so as to increase the achievable percentage of the financial goal.

A user can set up a financial goal by defining a goal timeline, specifying when they intend to achieve it, a target savings amount to accumulate by that point, and the amount they plan to contribute towards the goal from the current time until the specified timeline. However, the user may not be able to reach the entire savings amount based on their preferred contributions, the due date of the goal, and other factors, such as existing savings. Consequently, the user can only achieve a certain percentage of their savings goal.

To increase the funding percentage, users can modify their goal, considering options such as extending the timeline, contributing more, or adjusting the desired savings amount. At the same time, depending on user preferences and financial backgrounds, different components of the goal might be easier for one to modify than others. For example, one user who does not have overflow money at the end of the month might find it difficult to increase their contributions towards their goal, and they would rather extend the timeline of the goal by a few years.

Accordingly, an objective of the present inventive concept is to help suggest the best way to the user to alter their goal that will optimally find goal alternatives that are also tailored to the user by providing an optimization method that suggests the best set of alternatives to adjust their financial goal that are both tailored to their preferences and also aims to achieve a higher funding percentage.

In an exemplary embodiment, a Savings Planning Task is a tuple SPT={Gt, Gc, Gs, E, γ, F} where: 1) Gt∈N is the number of time steps by which the user would like to achieve their savings goal; 2) Gc∈R is the money the user would like to contribute per time step towards their savings goal; 3) Gs∈R is total amount that user would like to have saved at Gt time steps; 4) E(Gt, Gc, γ)=\hat{ }Gs, is an estimator function that returns the estimated savings Gt at time step Gt based on contributions Gc and an additional set of parameters γ; 5) γ is a set of parameters that can be passed in the savings estimator function; and 6) F=\hat{ }Gs/Gs, is the funding percentage of a user goal.

The financial goal of the user may include, for example, to accumulate a total savings of Gs across Gt time steps, with contributions of Gc during each individual time step. However, the user may face challenges in achieving the entire Gs target within the specified Gt time steps and with the contributions of Gc.

To estimate the user's savings, a savings estimator function denoted as E is utilized. This function considers the user's goal contributions Gc, the desired time steps Gt, and additional factors represented by γ to produce a savings estimate \hat{ }Gs representing the anticipated savings the user will have at the goal timeline Gt. E(Gc, Gt, γ)=\hat{ }Gs. These additional factors γ could include other sources of future income of the user, micro-economic considerations, macro-economic considerations, and more. The savings estimator function used for estimating their savings can vary, ranging from a simple future value calculation to a highly complex model.

In an exemplary embodiment, the funding percentage of the goal is defined as the ratio of the estimated savings Es over the user-specified desired savings amount Gs, expressed as: F=\hat{ }Gs/Gs. Depending on how the user selects their goal savings Gs, goal contributions Gc, and goal timeline Gt, the funding percentage can range from zero (0%) to one hundred (100%). For instance, if a user chooses to contribute a minimal amount over a short period while aiming for a substantial savings goal, their estimated savings at the goal time will be relatively low, resulting in a low funding percentage for their goal.

Solving Savings Planning Tasks: In an exemplary embodiment, an objective is to guide users on how to change their contributions or time steps to achieve their desired savings and therefore reach a higher funding percent of their goal. Even in cases where users can reach their savings goal with their proposed contributions and time steps, another objective is to help the users explore the vast space of “what-if?” scenarios, considering savings plans with different features such as having a high likelihood of the user following such a plan.

In an exemplary embodiment, the present inventive concept optimally suggests the best set of alternative financial goals that are tailored to the preferences of the user and that aim to achieve a higher funding percentage. To accomplish this, a definition is provided for three different sets C, T, and S, which account for the possible contributions, time steps and savings amounts, respectively. The elements of each set can be provided by domain experts, by users, or inferred from data.

In an exemplary embodiment, an alternative goal suggestion is a tuple goal suggestion= [symbol] c, t, s [symbol] , which suggest users how they should contribute c money during t time steps to achieve savings s. The number of these tuples is given by C×T×S, so it easily becomes possible to have very large numbers (e.g., millions) of goal suggestions. From this vast set, it is preferred to propose to the user only the best goal suggestions. In order to do that, it is proposed to assign a quality to each goal suggestion, such that this quality would show which solution is better than another. Although any quality function Q could be assigned to each of the tuples, in an exemplary embodiment, a proposed solution is considered to be of high quality when: 1) the proposed solution reaches a high funding percentage; 2) the proposed solution corresponds to a high degree of user preference which represents the willingness of a specific user to commit to the values of the tuple, where each element c∈C, t∈T and s∈S has an associated user preference; and 3) the proposed solution does not deviate excessively from the initial user input.

In an exemplary embodiment, the quality function Q may be expressed as follows:

Q(<c,t,s>)=W_{F}*F+(W_{PC}*PreferenceC(c)+W_{PT}*PreferenceT(t)+W_{PS}*PreferenceS(s))+(W_{DGc}(1−(|Gc−c|/Gc))+W_{DGt}(1−(|Gt−t|/Gt))+W_{DGs}(1−(|Gs−s|/Gs)),

where W_{F} is the weight assigned to the importance of funding percentage of a solution; F=\hat{ }s/s is the funding percentage of a solution; s is the savings of the goal triplet; and \hat{ }s=E(t, c, γ). E is an estimator function that returns the estimated savings s at time step t based on contributions c and an additional set of parameters γ. γ is a set of parameters that can be passed in the savings estimator function.

PreferenceC(c) is a number between 0 and 1 that represents the willingness of a specific user to commit to a value of contributions c. Similarly, PreferenceT(t) represents the willingness to commit to a value t of timesteps, and PreferenceS(s) represents the willingness to commit to a value s of savings.

(W_{PC}, W_{PT}, W_{PS}) are the weights assigned to each respective preference number for the contributions, timesteps and savings.

1−(|Gc−c|/Gc) is the deviation from the user input for the contributions value. This will have a maximum value of one (1) when the alternative contributions c is equal to the initial user goal contributions Gs. Similarly, 1−(|Gt−t|/Gt) is the deviation from the user input for the timesteps value t, and 1−(|Gs−s|/Gs) is the deviation from the user input for the savings value s.

(W_{DGc}, W_{DGt}, W_{DGs}) are the weights assigned to each respective deviation from user input for the contributions, timesteps and savings.

In an exemplary embodiment, the solution to a Savings Planning Task is set of n goal suggestions that 1) satisfy property X; and 2) maximize the quality sum Q. Any property X may be employed, but in an exemplary embodiment, the property X corresponds to diversity, which is defined as n triplets that do not share any element. For example, for three solutions of the Savings Planning Task, i.e., goal_suggestion_1=<c1, t1, s1>, goal_suggestion_2=<c2, t2, s2>, and goal_suggestion_3=<c3, t3, s3>, would each need to maximize Q and be diverse, i.e., c1≠c2≠c3 and t1≠t2≠t3 and s1≠s2≠s3.

Accordingly, with this technology, an optimized process for providing a tool for individualized financial planning and navigation that is tailored to user preferences and offers flexibility with respect to modifications in financial goals is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for providing a tool for individualized financial planning, the method being implemented by at least one processor, the method comprising:
receiving, by the at least one processor from a user, first information that relates to the user, the first information including at least one financial goal of the user;
applying, to the first information by the at least one processor, an optimization algorithm that is designed to analyze the first information with respect to the at least one financial goal; and
determining, by the at least one processor based on a result of the applying of the optimization algorithm to the first information, an achievable percentage of the at least one financial goal of the user and at least one recommendation for modifying the first information in order to increase the achievable percentage of the at least one financial goal of the user.

2. The method of claim 1, wherein the first information further includes a first predetermined number of time steps for achieving the at least one financial goal, a first amount of money that the user contributes per time step towards the at least one financial goal, and a second amount of money that the user expects to save after the first predetermined number of time steps.

3. The method of claim 2, wherein the applying of the optimization algorithm comprises:
assigning a first user preference that corresponds to a willingness of the user to commit to the first predetermined number of time steps;
assigning a second user preference that corresponds to a willingness of the user to commit to the first amount of money; and
assigning a third user preference that corresponds to a willingness of the user to commit to the second amount of money,
wherein each of the first user preference, the second user preference, and the third user preference is a real number within a range of between zero (0) and one (1).

4. The method of claim 3, wherein the applying of the optimization algorithm further comprises:
assigning a first weight that corresponds to the first user preference;
assigning a second weight that corresponds to the second user preference;
assigning a third weight that corresponds to the third user preference;
assigning a fourth weight that corresponds to an importance of a predetermined percentage of the second amount of money;
assigning a fifth weight that corresponds to a deviation from user input for the first predetermined number of time steps;
assigning a sixth weight that corresponds to a deviation from user input for the first amount of money; and
assigning a seventh weight that corresponds to a deviation from user input for the second amount of money,
wherein the determining of the achievable percentage of the at least one financial goal of the user and the determining of the at least one recommendation for modifying the first information are based on the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

5. The method of claim 4,
wherein the method further comprises:
generating a plurality of candidate recommendations for modifying the first information, each respective candidate recommendation comprising a respective tuple goal suggestion; and
determining a respective quality of the respective tuple goal suggestion by using each of the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

6. The method of claim 5, wherein the applying of the optimization algorithm further comprises selecting a predetermined number of tuple goal suggestions for which the respective quality exceeds a predetermined threshold and corresponding values of each selected tuple goal suggestion are mutually diverse.

7. The method of claim 6, wherein the predetermined number of tuple goal suggestions includes at least three mutually diverse tuple goal suggestions, including:
a first tuple goal suggestion having a second predetermined number of time steps that is greater than the first predetermined number of time steps for achieving the at least one financial goal, a third amount of money that is less than the first amount of money to be contributed by the user per time step towards the at least one financial goal, and a fourth amount of money that is different from the second amount of money to be saved by the user;
a second tuple goal suggestion having a third predetermined number of time steps that is less than the first predetermined number of time steps for achieving the at least one financial goal, a fifth amount of money that is greater than the first amount of money to be contributed by the user per time step towards the at least one financial goal, and a sixth amount of money that is different from each of the second amount of money and the fourth amount of money to be saved by the user; and
at least a third tuple goal suggestion having a fourth predetermined number of time steps that is different from each of the first predetermined number of time steps, the second predetermined number of time steps, and the third predetermined number of time steps for achieving the at least one financial goal, a seventh amount of money that is different from each of the first amount of money, the third amount of money, and the fifth amount of money to be contributed by the user per time step towards the at least one financial goal, and an eighth amount of money that is different from each of the second amount of money, the fourth amount of money, and the sixth amount of money to be saved by the user.

8. The method of claim 1, further comprising displaying, by the at least one processor on a user interface, a result of the determining of the achievable percentage of the at least one financial goal of the user and the at least one recommendation for modifying the first information.

9. A computing apparatus for providing a tool for individualized financial planning, the computing apparatus comprising:
a processor;
a memory;
a display; and
a communication interface coupled to each of the processor, the memory, and the display,
wherein the processor is configured to:
receive, from a user via the communication interface, first information that relates to the user, the first information including at least one financial goal of the user;
apply, to the first information, an optimization algorithm that is designed to analyze the first information with respect to the at least one financial goal; and
determine, based on a result of the application of the optimization algorithm to the first information, an achievable percentage of the at least one financial goal of the user and at least one recommendation for modifying the first information in order to increase the achievable percentage of the at least one financial goal of the user.

10. The computing apparatus of claim 9, wherein the first information further includes a first predetermined number of time steps for achieving the at least one financial goal, a first amount of money that the user contributes per time step towards the at least one financial goal, and a second amount of money that the user expects to save after the first predetermined number of time steps.

11. The computing apparatus of claim 10, wherein the processor is further configured to perform the applying of the optimization algorithm by:
assigning a first user preference that corresponds to a willingness of the user to commit to the first predetermined number of time steps;
assigning a second user preference that corresponds to a willingness of the user to commit to the first amount of money; and
assigning a third user preference that corresponds to a willingness of the user to commit to the second amount of money,
wherein each of the first user preference, the second user preference, and the third user preference is a real number within a range of between zero (0) and one (1).

12. The computing apparatus of claim 11, wherein the processor is further configured to perform the applying of the optimization algorithm by:
assigning a first weight that corresponds to the first user preference;
assigning a second weight that corresponds to the second user preference;
assigning a third weight that corresponds to the third user preference;
assigning a fourth weight that corresponds to an importance of a predetermined percentage of the second amount of money;
assigning a fifth weight that corresponds to a deviation from user input for the first predetermined number of time steps;
assigning a sixth weight that corresponds to a deviation from user input for the first amount of money; and
assigning a seventh weight that corresponds to a deviation from user input for the second amount of money,
wherein the determination of the achievable percentage of the at least one financial goal of the user and the determination of the at least one recommendation for modifying the first information are based on the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

13. The computing apparatus of claim 12,
wherein the processor is further configured to:
generate a plurality of candidate recommendations for modifying the first information, each respective candidate recommendation comprising a respective tuple goal suggestion; and
determine a respective quality of the respective tuple goal suggestion by using each of the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.

14. The computing apparatus of claim 13, wherein the processor is further configured to perform the applying of the optimization algorithm by selecting a predetermined number of tuple goal suggestions for which the respective quality exceeds a predetermined threshold and corresponding values of each selected tuple goal suggestion are mutually diverse.

15. The computing apparatus of claim 14, wherein the predetermined number of tuple goal suggestions includes at least three mutually diverse tuple goal suggestions, including:
a first tuple goal suggestion having a second predetermined number of time steps that is greater than the first predetermined number of time steps for achieving the at least one financial goal, a third amount of money that is less than the first amount of money to be contributed by the user per time step towards the at least one financial goal, and a fourth amount of money that is different from the second amount of money to be saved by the user;
a second tuple goal suggestion having a third predetermined number of time steps that is less than the first predetermined number of time steps for achieving the at least one financial goal, a fifth amount of money that is greater than the first amount of money to be contributed by the user per time step towards the at least one financial goal, and a sixth amount of money that is different from each of the second amount of money and the fourth amount of money to be saved by the user; and
at least a third tuple goal suggestion having a fourth predetermined number of time steps that is different from each of the first predetermined number of time steps, the second predetermined number of time steps, and the third predetermined number of time steps for achieving the at least one financial goal, a seventh amount of money that is different from each of the first amount of money, the third amount of money, and the fifth amount of money to be contributed by the user per time step towards the at least one financial goal, and an eighth amount of money that is different from each of the second amount of money, the fourth amount of money, and the sixth amount of money to be saved by the user.

16. The computing apparatus of claim 9, wherein the processor is further configured to cause the display to display, on a user interface, a result of the determination of the achievable percentage of the at least one financial goal of the user and the at least one recommendation for modifying the first information.

17. A non-transitory computer readable storage medium storing instructions for providing a tool for individualized financial planning, the storage medium comprising a set of executable code which, when executed by a processor, causes the processor to:
receive, from a user, first information that relates to the user, the first information including at least one financial goal of the user;
apply, to the first information, an optimization algorithm that is designed to analyze the first information with respect to the at least one financial goal; and
determine, based on a result of the application of the optimization algorithm to the first information, an achievable percentage of the at least one financial goal of the user and at least one recommendation for modifying the first information in order to increase the achievable percentage of the at least one financial goal of the user.

18. The storage medium of claim 17, wherein the first information further includes a first predetermined number of time steps for achieving the at least one financial goal, a first amount of money that the user contributes per time step towards the at least one financial goal, and a second amount of money that the user expects to save after the first predetermined number of time steps.

19. The storage medium of claim 18, wherein when executed by the processor, the executable code further causes the processor to apply the optimization algorithm by:
assigning a first user preference that corresponds to a willingness of the user to commit to the first predetermined number of time steps;
assigning a second user preference that corresponds to a willingness of the user to commit to the first amount of money; and
assigning a third user preference that corresponds to a willingness of the user to commit to the second amount of money,
wherein each of the first user preference, the second user preference, and the third user preference is a real number within a range of between zero (0) and one (1).

20. The storage medium of claim 19, wherein when executed by the processor, the executable code further causes the processor to apply the optimization algorithm by:
assigning a first weight that corresponds to the first user preference;
assigning a second weight that corresponds to the second user preference;
assigning a third weight that corresponds to the third user preference;
assigning a fourth weight that corresponds to an importance of a predetermined percentage of the second amount of money;
assigning a fifth weight that corresponds to a deviation from user input for the first predetermined number of time steps;
assigning a sixth weight that corresponds to a deviation from user input for the first amount of money; and
assigning a seventh weight that corresponds to a deviation from user input for the second amount of money,
wherein the determination of the achievable percentage of the at least one financial goal of the user and the determination of the at least one recommendation for modifying the first information are based on the assigned first user preference, the assigned second user preference, the assigned third user preference, the assigned first weight, the assigned second weight, the assigned third weight, the assigned fourth weight, the assigned fifth weight, the assigned sixth weight, and the assigned seventh weight.
